(19) United States
(12) Patent Application Publication
(10) Pub. No.: US 2007/0146588 A1
(43) Pub. Date: Jun. 28, 2007

(54) Reflective liquid crystal display devices integrating self-emitting display element and fabrication methods thereof

(75) Inventors: Bo-Ru Yang, Taipei County (TW); Hsing-Lung Wang, Taoyuan County (TW); Chi-Chang Liao, Tainan (TW); Kang-Hung Liu, Hsinchu (TW); Shie-Chang Jeng, Pingtung County (TW); Han-Ping Shieh, Hsinchu City (TW)

Correspondence Address: QUINTERO LAW OFFICE, PC, 2210 MAIN STREET, SUITE 200, SANTA MONICA, CA, 90405, US

(73) Assignee: INDUSTRIAL TECHNOLOGY RESEARCH INSTITUTE, HSINCHU (TW)

(21) Appl. No.: 11/491,719

(22) Filed: Jul. 24, 2006

(30) Foreign Application Priority Data
Dec. 23, 2005 (TW) TW94146104

(51) Int. Cl. G02F 1/1335

(52) U.S. Cl. 349/113

(57) ABSTRACT

A reflective liquid crystal display device integrating a self-emitting display element and fabrication methods thereof. The reflective liquid crystal display integrating a self-emitting display element comprises a reflective liquid crystal display (LCD) device and a transparent self-emitting display element directly disposed on the reflective LCD device. The reflective LCD includes a reflective cholesterol liquid crystal display, a reflective polymer dispersed liquid crystal display, a reflective twisted nematic liquid crystal display, a reflective smectic liquid crystal display, a vertical aligned liquid crystal (VA-LC) display, or a ferro-electric liquid crystal display.

### BACKGROUND OF THE INVENTION

1. Field of the Invention

The present invention relates to liquid crystal display (LCD) devices and fabrication methods thereof, and in particular to reflective liquid crystal display devices integrating self-emitting display elements and fabrication methods thereof.

2. Description of the Related Art

Liquid crystal display (LCD) devices have many advantages such as small volume, light weight and low power consumption, and are applicable in a variety of electronic and communication devices including notebook computers, personal digital assistants (PDA), mobile phones and the like, due to their lighter weight, thinner profile, and increased portability. Conventional reflective liquid crystal displays, however, can not achieve desirable brightness and contrast ratio in a dark ambience.

As self-emitting display technologies develop, display luminance has improved. For example, organic light emitting display (OLED) devices have more efficient power consumption. A self-emitting display device, however, can be washed out in a bright ambience causing low contrast images. Accordingly, a reflective liquid crystal display device integrating a self-emitting device is required in both dark and bright ambiences.

U.S. Publication No. 2004/0164292, the entirety of which is hereby incorporated by reference, discloses a reflective liquid crystal display device integrating a self-emitting device, using an organic light emitting display as a backlight unit of the reflective liquid crystal display device to improve brightness and contrast ratio in a dark ambience. FIG. 1 is a cross section of a conventional reflective liquid crystal display device integrating a self-emitting display element. Referring to FIG. 1, a reflective electrode 22, an organic light emitting layer 24, and a transparent electrode 26 are sequentially formed on a substrate 10. A self-emitting element 20 including the reflective electrode 22, the organic light emitting layer 24, and the transparent electrode 26 serves as a backlight unit of the reflective liquid crystal display device. A passivation layer 28 is formed on the transparent electrode 26.

A liquid crystal display 30 including a first polarizer 31 is disposed on the second substrate 32. A pixel electrode 33 is disposed on the second substrate 32. A third substrate 36 opposing the second substrate 32 has a common electrode 35 thereon. A liquid crystal layer is interposed between the second substrate 32 and the third substrate 36. A second polarizer 37 is disposed on the third substrate 37. In transmission mode, light emitted from the self-emitting display element 20 passes through the reflective liquid crystal display 30 to display images. In reflection mode, incident light 62 passing through the reflective liquid crystal display 30 is reflected by a reflective electrode 22. Reflective light 63 then passes through the reflective liquid crystal display 30 to display images.

U.S. Publication No. 2002/0196387 and U.S. Publication No. 2003/0201960, the entirety of which are hereby incorporated by reference, disclose a reflective liquid crystal display disposed on a self-light emitting display element. In a dark ambience, however, the self-emitting display element emits light passing through the liquid crystal layer, color filters and polarizers, causing deviation of emitted light. Conversely, in a bright ambience, the self-light emitting display element serves as a reflector and reflects incident light passing through the liquid crystal device. The incident light, however, can be absorbed by the liquid crystal layer and the absorption of the liquid crystal layer in both bright and dark states can be different, causing variation of contrast ratio. Display quality in conventional reflective liquid crystal display devices suffers due to absorption of incident light.

### BRIEF SUMMARY OF THE INVENTION

A detailed description is given in the following embodiments with reference to the accompanying drawings.

Accordingly, a stacked reflective liquid crystal display device integrating a self-emitting display element is provided. The self-emitting display element is disposed on the reflective liquid crystal display device to prevent washout effect in a bright ambience and improve contrast ratio of the display device in a dark ambience.

An exemplary embodiment of a reflective liquid crystal display device integrating a self-emitting display element comprises a reflective liquid crystal display element, and a transparent self-emitting display element directly disposed on the reflective liquid crystal display element. The reflective liquid crystal display element comprises a first substrate with an absorption layer thereon, a first transparent electrode disposed on the absorption layer, a cholesterol mode liquid crystal layer disposed on the first transparent electrode, a second transparent electrode disposed on the cholesterol mode liquid crystal layer, and a second substrate disposed on the second transparent electrode.

Another exemplary embodiment of a reflective liquid crystal display device integrating a self-emitting display element comprises: a substrate with a reflective layer thereon; a first transparent electrode disposed on the reflective layer; a reflective liquid crystal layer disposed on the first transparent electrode; and a second transparent electrode disposed on the cholesterol mode liquid crystal layer. A passivation layer is disposed on the second transparent electrode. A transparent self-emitting display element is disposed on the passivation layer comprising a third electrode disposed on the passivation layer, a light emitting layer disposed on the third electrode, a fourth electrode disposed on the light emitting layer, and a second substrate disposed on the fourth electrode.

According to another embodiment of the invention, a method for fabricating a reflective liquid crystal display device integrating a self-emitting display element is provided. A substrate with an optical-function layer thereon is provided. A first transparent electrode is formed on the optical-function layer. A reflective liquid crystal layer is applied on the first transparent electrode. A second transparent electrode is formed on the reflective liquid crystal layer. A passivation layer is formed on the second transparent electrode. A third electrode is disposed on the passivation layer. A light emitting layer is formed on the third electrode. A fourth electrode is formed on the light emitting layer.

According to another embodiment of the invention, a method for fabricating a reflective liquid crystal display device integrating a self-emitting display element is provided. A first substrate with a transparent self-emitting display element thereon is provided. A passivation layer is formed on the transparent self-emitting display element. A first electrode is formed on the passivation layer. A second substrate with a second electrode thereon is provided. The first substrate is assembled opposing the second substrate with a gap therebetween. A liquid crystal layer is injected between the first and the second substrates. An optical-function layer is formed on the second substrate.

### BRIEF DESCRIPTION OF THE DRAWINGS

The present invention can be more fully understood by reading the subsequent detailed description and examples with references made to the accompanying drawings, wherein:

FIG. 1 is a cross section of a conventional reflective liquid crystal display device integrating self-emitting display element;

FIG. 2A is a stereographical view of a reflective liquid crystal display device integrating a self-emitting display element according to an embodiment of the invention;

FIG. 2B is a schematic view of the reflective liquid crystal display device of FIG. 2A in the “on” state;

FIG. 3 is a flowchart of a fabrication method of a reflective liquid crystal display device integrating a self-emitting display element according to an embodiment of the invention;

FIG. 4 is a stereographical view of the reflective liquid crystal display device formed by the fabrication method of FIG. 3;

FIG. 5 is a flowchart of a fabrication method of a reflective liquid crystal display device integrating a self-emitting display element according to another embodiment of the invention;

FIG. 6 is a stereographical view of the reflective liquid crystal display device formed by the fabrication method of FIG. 5; and

FIG. 7 is a stereographical view of an organic light emitting display element according to an embodiment of the invention.

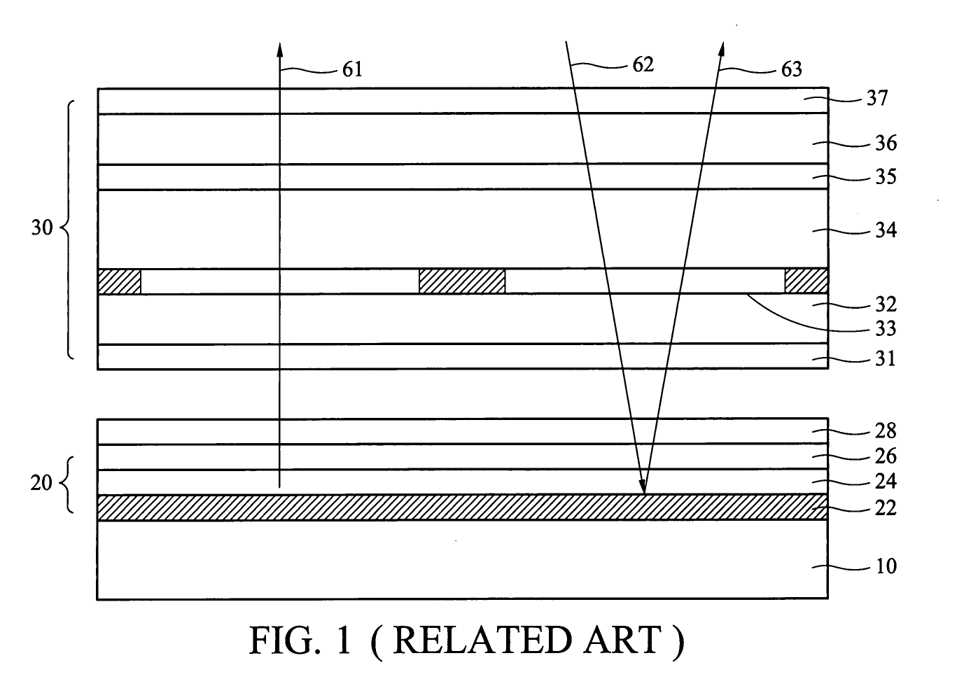

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

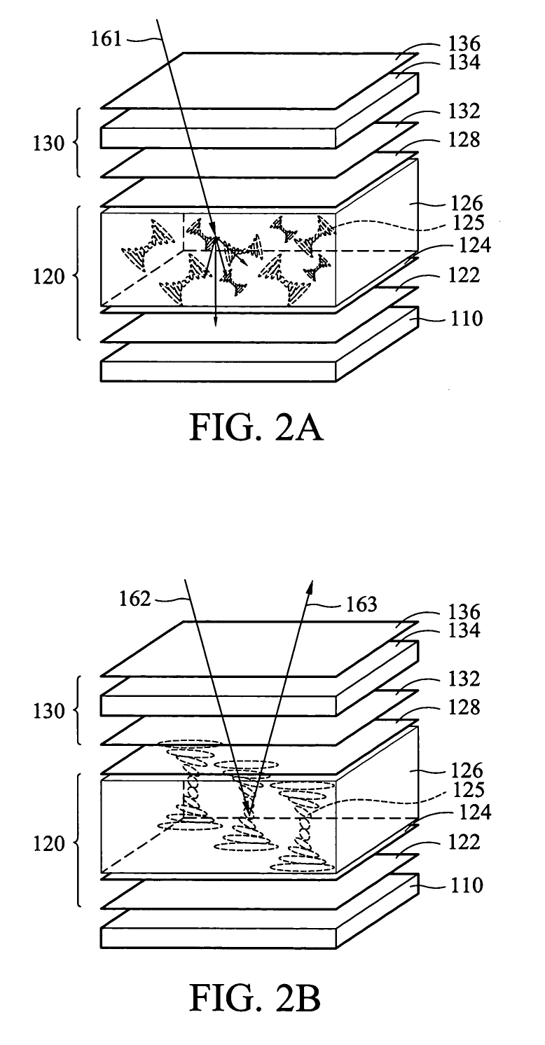

FIG. 2A is a stereographical view of a reflective liquid crystal display device integrating a self-emitting display element according to an embodiment of the invention. Referring to FIG. 2A, a reflective liquid crystal display element 120 is disposed on a first substrate 110. The reflective liquid crystal display element 120 comprises a reflective cholesterol mode liquid crystal display, a polymer dispersed liquid crystal (PDLC) display, a reflective twisted nematic (TN) mode liquid crystal display, a reflective sematic liquid crystal display, a vertical aligned liquid crystal (VA-LC) display, or a reflective ferroelectric liquid crystal display.

An optical-function layer 122 comprising a reflective layer or an absorption is disposed on the first substrate 110. A first transparent electrode 124 is disposed on the optical-function layer 122. A reflective liquid crystal layer 126 is disposed on the first transparent electrode 124. A second transparent electrode 128 is disposed on the cholesterol mode liquid crystal layer 126. According to an embodiment of the invention, the reflective liquid crystal display element 120 can further comprise a second substrate (not shown) on the second transparent electrode 128. Alternatively, the second substrate can be a passivation layer, a thin film stacking alyer, a glass substrate, or a plastic substrate disposed on the second transparent electrode 128. Moreover, the reflective liquid crystal display element 120 can further comprise a phase retardation film, a color filter and/or a polarizer on the second substrate.

A transparent self-emitting display element 130 is directly disposed on the reflective liquid crystal display element 120. The transparent self-emitting display element 130 comprises a third electrode 132 disposed on the reflective liquid crystal display element 120. A light-emitting layer 134 is disposed on the third electrode 132. A fourth electrode 136 is disposed on the light-emitting layer 134. According to an embodiment of the invention, the transparent self-emitting display element 130 can further comprise a carrier injection layer interposed between the third electrode 132 and the light-emitting layer 134. Moreover, another carrier injection layer can be interposed between the light-emitting layer 134 and the fourth electrode 136.

The reflective liquid crystal display device integrating a self-emitting display element may further comprise an array of micro-lens structures or a micro-optical grating disposed on the transparent self-emitting display element 130.

In FIG. 2A, when the reflective liquid crystal display element 120 is switched off, the liquid crystal molecules 125 of the liquid crystal layer 126 is randomly dispersed. Incident ambient light 161 passes through the transparent self-emitting display element 130 and is scattered by randomly dispersed liquid crystal molecules 125, and further absorbed by the absorption layer 122, thus displaying a “dark” state.

FIG. 2B is a schematic view of the reflective liquid crystal display device of FIG. 2A in the “on” state. In FIG. 2B, when the reflective liquid crystal display element 120 is switched on, the liquid crystal molecules 125 of the liquid crystal layer 126 is regularly aligned with the applied electric field. Incident ambient light 162 passes through the liquid crystal layer 126 and is reflected by regularly aligned liquid crystal molecules 125 (reflective light 163 in FIG. 2A), thus displaying a “bright” state.

Accordingly, the transparent self-emitting display element 130 directly disposed on the reflective liquid crystal display element 120 is advantageous in that when ambient light is dark, the transparent self-emitting display element 130 serves as a primary display element. The self-emitting display element 130 emits light without passing through the reflective liquid crystal display element 120. Additional polarizers and color filters are unnecessary, and the display quality is not affected due to additional polarizers and color filters. On the other hand, when ambient light is bright, the reflective liquid crystal display element 120 serves as a primary display element. Although the ambient light must pass through the transparent self-emitting display element 130 and the reflective liquid crystal display element 120 causing absorption of the ambient light. The absorption of the ambient light, however, does not affect image contrast ratio and power consumption of the display device.

Note that the reflective liquid crystal display device integrating a self-emitting display element according to an embodiment of the invention does not limit to reflective liquid crystal display elements. Other liquid crystal display elements or light modulating devices are also applicable thereto. Moreover, the transparent self-emitting display element comprises an organic light emitting display element or an inorganic light emitting display element.

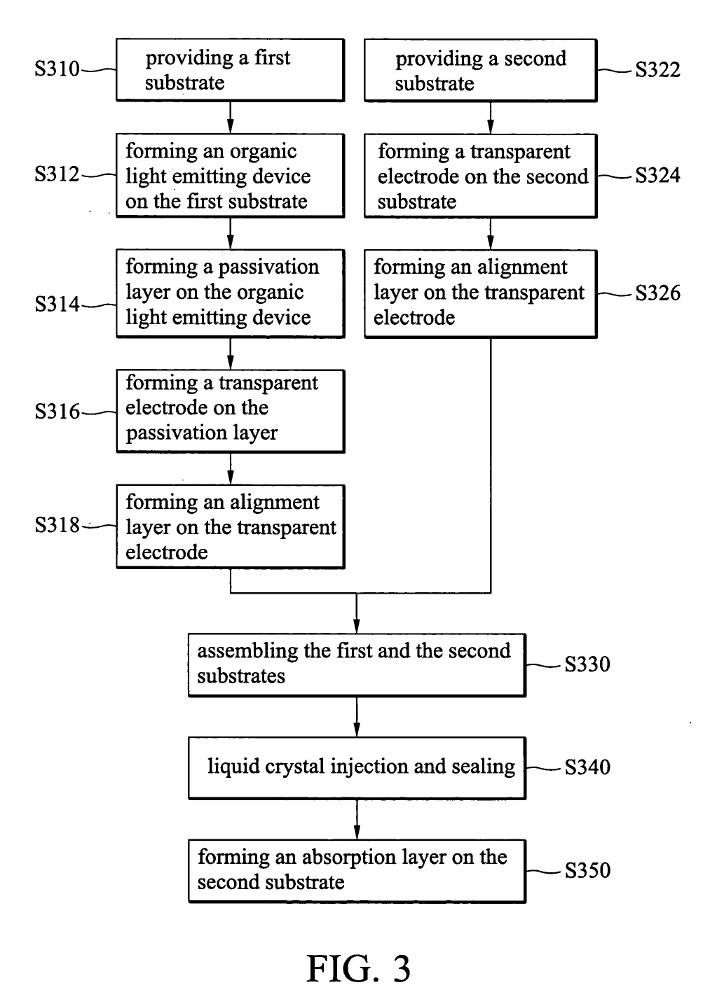

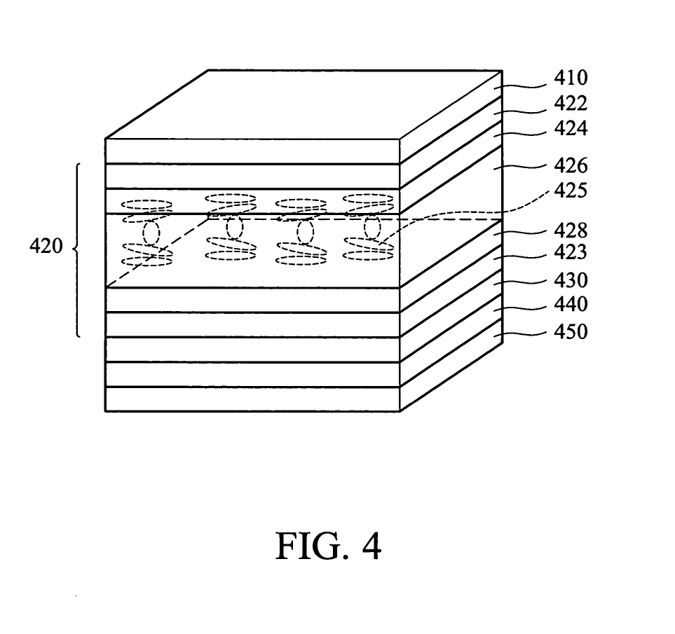

FIG. 3 is a flowchart of a fabrication method of a reflective liquid crystal display device integrating a self-emitting display element according to an embodiment of the invention. FIG. 4 is a stereographical view of the reflective liquid crystal display device formed by the fabrication method of FIG. 3. In an aspect of the invention, an organic light emitting display element is formed before a reflective liquid crystal display element is formed.

Referring to FIGS. 3 and 4, a first substrate 450 is provided in step S310. Next, in step S312, an organic light-emitting display element 440 is formed on the first substrate 450 comprising sequentially forming a transparent cathode on the first substrate 450, forming an organic light emitting layer on the transparent cathode, and forming a transparent anode on the organic light emitting layer. In step S314, a passivation layer 430 is formed on the organic light-emitting display element 440. Subsequently, in step S316, a transparent electrode 423 such as indium tin oxide (ITO) is formed on the passivation layer 430. In step S318, an alignment layer 428 such as polyimide (PI) is applied on the transparent electrode 423 by roll coating.

A second substrate 410 is provided in step S322. Subsequently, in step S324, a transparent electrode 422 such as indium tin oxide (ITO) is formed on the second substrate 410. In step S326, an alignment layer 424 such as polyimide (PI) is applied on the transparent electrode 422 by roll coating.

In step S330, the second substrate 410 is assembled opposing the first substrate 450 with spacers interposed therebetween to maintain a specific gap. Subsequently, in step S340, a liquid crystal layer 426 is injected between the first and second substrates and sealed. Next, an optical-function layer (not shown) is formed on the second substrate 410 in step S350, thus completing the reflective liquid crystal display device integrating a self-emitting display element.

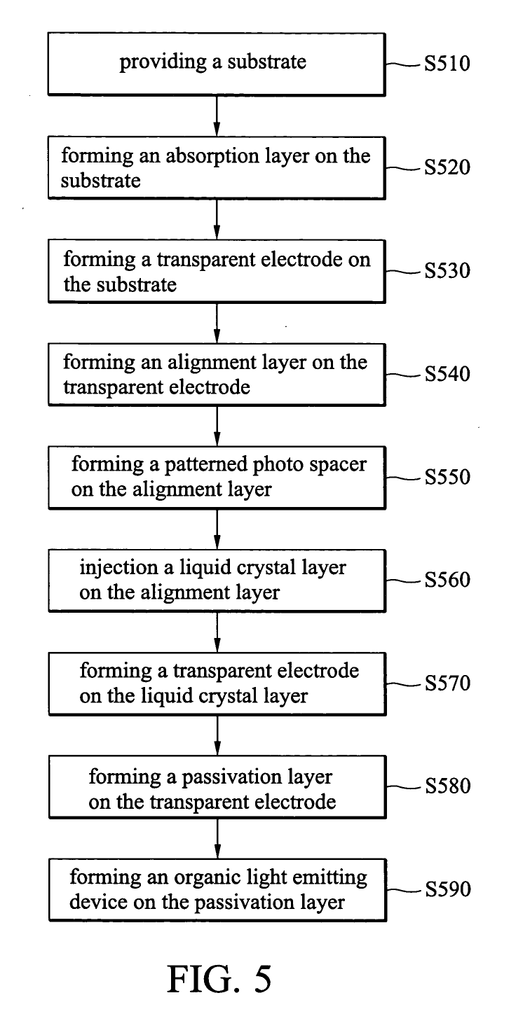

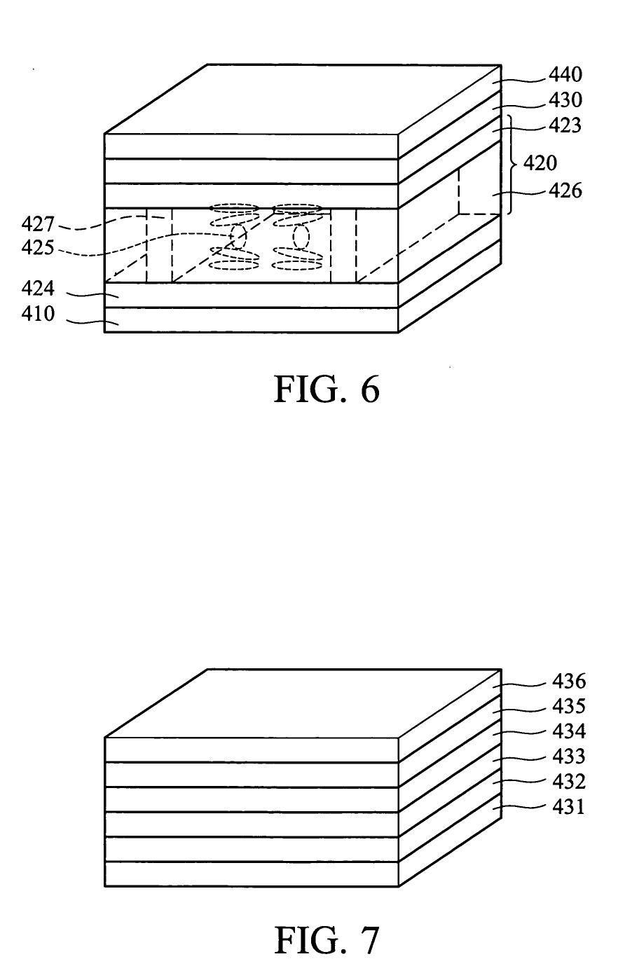

FIG. 5 is a flowchart of a fabrication method of a reflective liquid crystal display device integrating a self-emitting display element according to another embodiment of the invention. FIG. 6 is a stereographical view of the reflective liquid crystal display device formed by the fabrication method of FIG. 5. In another aspect of the invention, a reflective liquid crystal display element is formed before an organic light emitting display element is formed.

Referring to FIGS. 5 and 6, a substrate 410 is provided in step S510. Next, in step S520, an optical-function layer (not shown) is formed on the substrate 410. Subsequently, in step S530, a transparent electrode 424 such as indium tin oxide (ITO) is formed on the substrate 410. In step S540, an alignment layer (not shown) such as polyimide (PI) is applied on the transparent electrode 424 by roll coating.

In step S550, patterned photoresist spacers 427 are formed on the alignment layer. The patterned photoresist spacers 427 can be wall structures dividing a plurality of pixel regions. In step S560, a liquid crystal layer 426 is formed on the alignment layer by inkjet printing. Subsequently, in step S570, a transparent electrode 423 such as indium tin oxide (ITO) is formed on the liquid crystal layer 426. In step S580, a passivation layer 430 is formed on the transparent electrode 423. In step S590, an organic light emitting display element 440 is formed on the passivation layer 430, comprising sequentially forming a transparent cathode on the passivation layer, forming an organic light emitting layer on the transparent cathode, and forming a transparent anode on the organic light emitting layer.

FIG. 7 is a stereographical view of an organic light emitting display element according to an embodiment of the invention. Referring to FIG. 7, an organic light emitting display element 440 comprises an anode 431 such as a transparent indium tin oxide (ITO) layer. A hole injection layer (HIL) 432 such as CuPc is formed on the anode 431. A hole transportation layer (HTL) 433 such as NPB is formed on the hole injection layer (HIL) 432. An organic light emitting layer 434 such as Alq₃ is formed on the hole transportation layer (HTL) 433. An electron injection layer (EIL) 435 such as LiF is formed on the organic light emitting layer 434. A cathode 436 such as Al and transparent electrode composite structure is formed on the electron injection layer (EIL) 435.

The invention is advantageous in that a stacked reflective liquid crystal display device integrating a self-emitting display element is provided. When the ambience is bright, a reflective image is displayed, and when the ambience is dark, an image is displayed by an organic light emitting display element. The backlight unit (BLU), color filters and polarizers can be omitted, thereby reducing production cost.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A reflective liquid crystal display device integrating a self-emitting display element, comprising:
a reflective liquid crystal display element; and
a transparent self-emitting display element directly disposed on the reflective
liquid crystal display element.

2. The reflective liquid crystal display device as claimed in claim 1, wherein the reflective liquid crystal display element comprises a reflective cholesterol mode liquid crystal display, a polymer dispersed liquid crystal (PDLC) display, a reflective twisted nematic (TN) mode liquid crystal display, a reflective sematic liquid crystal display, a vertical aligned liquid crystal (VA-LC) display, or a reflective ferroelectric liquid crystal display.

3. The reflective liquid crystal display device as claimed in claim 2, wherein the reflective cholesterol mode liquid crystal display comprises:
a first substrate with an absorption layer thereon;
a first transparent electrode disposed on the absorption layer;
a cholesterol mode liquid crystal layer disposed on the first transparent electrode;
a second transparent electrode disposed on the cholesterol mode liquid crystal layer; and
a second substrate disposed on the second transparent electrode.

4. The reflective liquid crystal display device as claimed in claim 3, wherein the second substrate comprises a passivation layer, a thin film stacking layer, a glass substrate, or a plastic substrate.

5. The reflective liquid crystal display device as claimed in claim 3, further comprising an alignment layer or a stabilizing layer interposed between the cholesterol mode liquid crystal layer and the first transparent electrode.

6. The reflective liquid crystal display device as claimed in claim 3, further comprising a phase retardation film, a color filter, and/or a polarizer on the second substrate.

7. The reflective liquid crystal display device as claimed in claim 1, wherein the transparent self-emitting display element comprises:
a third electrode disposed on the reflective liquid crystal display element;
a light emitting layer disposed on the third electrode;
a fourth electrode disposed on the light emitting layer; and
a third substrate disposed on the fourth electrode.

8. The reflective liquid crystal display device as claimed in claim 7, wherein the light emitting layer comprises an organic material or an inorganic material.

9. A reflective liquid crystal display device integrating a self-emitting display element, comprising:
a reflective liquid crystal display element, comprising:
a first substrate with a reflective layer thereon;
a first transparent electrode disposed on the reflective layer;
a reflective liquid crystal layer disposed on the first transparent electrode;
a second transparent electrode disposed on the liquid crystal layer;
a passivation layer disposed on the second transparent electrode; and
a transparent self-emitting display element on the passivation layer comprising:
a third electrode disposed on the passivation layer;
a light emitting layer disposed on the third electrode;
a fourth electrode disposed on the light emitting layer; and
a second substrate disposed on the fourth electrode.

10. The reflective liquid crystal display device as claimed in claim 9, further comprising an alignment layer or a stabilized layer interposed between the reflective liquid crystal layer and the first transparent electrode.

11. The reflective liquid crystal display device as claimed in claim 9, further comprising an alignment layer or a stabilized layer interposed between the reflective liquid crystal layer and the second transparent electrode.

12. The reflective liquid crystal display device as claimed in claim 9, further comprising a phase retardation film, a color filter, and/or a polarizer on the passivation layer.

13. The reflective liquid crystal display device as claimed in claim 9, wherein the light emitting layer comprises an organic material or an inorganic material.

14. The reflective liquid crystal display device as claimed in claim 9, wherein the reflective liquid crystal display element comprises a reflective cholesterol mode liquid crystal display, a polymer dispersed liquid crystal (PDLC) display, a reflective twisted nematic (TN) mode liquid crystal display, a reflective sematic liquid crystal display, vertical aligned liquid crystal (VA-LC) display, or a reflective ferroelectric liquid crystal display.

15. A method of fabricating a reflective liquid crystal display device integrating a self-emitting display element, comprising:
providing a substrate with an optical function layer thereon;
forming a first transparent electrode on the absorption layer;
applying a reflective liquid crystal layer on the first transparent electrode;
forming a second transparent electrode on the reflective liquid crystal layer layer;
forming a passivation layer on the second transparent electrode;
forming a third electrode on the passivation layer;
forming a light emitting layer on the third electrode; and
forming a fourth electrode on the light emitting layer.

16. The method as claimed in claim 15, wherein the liquid crystal layer is applied by blade coating or inkjet printing.

17. The method as claimed in claim 15, wherein the optical-function layer is a reflective layer or an absorption layer.

18. A method of fabricating a reflective liquid crystal display device integrating a self-emitting display element, comprising:
providing a first substrate with a transparent self-emitting display element thereon;
forming a passivation layer on the transparent self-emitting display element;
forming a first electrode on the passivation layer;
providing a second substrate with a second electrode thereon;
assembling the first substrate opposing the second substrate with a gap therebetween;
injecting a liquid crystal layer between the first and the second substrates; and
forming an optical-function layer on the second substrate.

19. The method as claimed in claim 18, wherein the passivation layer comprises a UV cured polymer layer, a thin film stacking layer, a glass substrate, or a plastic substrate.

20. The method as claimed in claim 18, further after the wherein the step of applying a first alignment layer, further comprising forming a phase retardation film and/or a polarizer on the passivation layer.
